(19) United States
(12) Patent Application Publication
(10) Pub. No.: US 2015/0274100 A1
(43) Pub. Date: Oct. 1, 2015

(54) APPARATUS AND METHOD OF AUTOMATICALLY CONTROLLING CONVENIENT DEVICE FOR VEHICLE

(71) Applicant: HYUNDAI MOTOR COMPANY, Seoul (KR)

(72) Inventors: Jong Duck KWAK, Gwacheon-Si (KR); Youngwoon JO, Paju-Si (KR); Seung-Chang PARK, Seoul (KR)

(21) Appl. No.: 14/555,991

(22) Filed: Nov. 28, 2014

(30) Foreign Application Priority Data
Mar. 27, 2014 (KR) 10-2014-0036043

(51) Int. Cl. B60R 16/037

(52) U.S. Cl. CPC B60R 16/037

(57) ABSTRACT

An apparatus and a method of automatically controlling a convenient device for a vehicle includes a macro generator configured to collect control values of a driver for a plurality of convenient devices for the vehicle to learn a control pattern of the driver, to collect environmental information when the control pattern is generated, and to generate a macro by matching the learned control pattern with the environmental information. A macro provider is configured to identify the driver in the vehicle, to collect the environmental information when the driver boards the vehicle, to search for the macro corresponding to the identified driver and the environmental information, and to provide macro search results to the driver when the driver is the vehicle.

### CROSS-REFERENCE TO RELATED APPLICATION

This application claims the benefit of priority to Korean Patent Application No. 10-2014-0036043 filed in the Korean Intellectual Property Office on Mar. 27, 2014, the entire contents of which are incorporated herein by reference.

### TECHNICAL FIELD

The present disclosure relates to an apparatus and a method of automatically controlling a convenient device for a vehicle.

### BACKGROUND

Generally, a driver manipulates convenient devices within the vehicle to optimize a driving condition before or while driving. For example, the driver operates an air conditioner to control a temperature inside the vehicle, controls an audio to play the music, or operates navigation to find an optimal path to a destination. The manipulation of the convenient devices within the vehicle is different according to driving habits of each driver, and therefore, the manipulation patterns are consistent for each driver.

Therefore, a technology of learning the manipulation patterns of the driver for the convenient devices within the vehicle and automatically controlling the convenient devices within the vehicle using the learning value has been recently developed.

However, according to the related art, a driver may only individually perform an automatic control on the convenient devices within the vehicle depending on the learning values for the manipulation of the convenient devices within the vehicle but may not automatically perform convenient devices at a constant time interval or a constant order. Further, the related art does not complexly consider external environmental variables, for example, a current position of the vehicle, time, weather, or the like, and as a result, may not provide flexibility in controlling the convenient devices.

The above information disclosed in this Background section is only for enhancement of understanding of the background of the disclosure, and therefore, it may contain information that does not form the prior art that is already known in this country to a person of ordinary skill in the art.

### SUMMARY

The present disclosure has been made in an effort to provide an apparatus and a method of automatically controlling a convenient device for a vehicle having advantages of automatically controlling convenient devices within the vehicle using a macro generated control values for the convenient device within the vehicle and external environmental information.

According to an exemplary embodiment of the present inventive concept, an apparatus of automatically controlling a convenient device for a vehicle includes a macro generator configured to collect control values of a driver for a plurality of convenient devices for the vehicle to learn a control pattern of the driver, to collect environmental information when the control pattern is generated, and to generate a macro by matching the learned control pattern with the environmental information. A macro provider is configured to identify the driver in the vehicle, to collect the environmental information, to search for the macro corresponding to the identified driver and the environmental information, and to provide macro search results to the driver when the driver board the vehicle.

The apparatus may further include a macro recommender configured to search for drivers of other vehicles including driver information corresponding to the identified driver and search for macro information corresponding to the searched drivers of the other vehicles based on driver information of the other vehicles collected by the information collector and the macro information corresponding to the driver information of the other vehicles.

The macro generator may set the macro based on at least one environmental information set by the driver.

The macro provider may sense at least one of a portable terminal of the driver connected by near field communication to control the convenient devices, a seat position, and an identification (ID) input from the driver to identify the driver.

The macro provider may automatically control the plurality of convenient devices based on the macro selected by the identified driver.

When the macro generator senses a manual control by the driver while the plurality of convenient devices are controlled, a new macro may be generated based on manual control values.

The environmental information may include at least one of date, day, time, season, a position of a vehicle, and weather information.

The control pattern may include at least one of a control order, control values, and a control frequency for the plurality of convenient devices.

According to another embodiment of the present inventive concept, a method of automatically controlling a convenient device for a vehicle includes collecting control values of a driver for a plurality of convenient devices for the vehicle. A control pattern of the driver is learned based on the control values. Environmental information is collected when the control pattern is generated. A macro is generated by matching the learned control pattern with the environmental information.

The method may further include identifying the driver in the vehicle. The environmental information is collected when the driver boards the vehicle. A macro corresponding to the identified driver and the environmental information is searched at the time at which the identified driver boards the vehicle. Macro search results are provided to the identified driver.

The method may further include collecting driver information of other vehicles and macro information corresponding thereto from a remote center or the other vehicles. Drivers of the other vehicles including driver information corresponding to the identified driver are searched. The macro information corresponding to the searched drivers of the other vehicles is provided to the identified driver.

The method may further include automatically controlling the plurality of convenient devices based on the macro selected by the identified driver among the macro search results.

The environmental information may include at least one of date, day, time, season, and position of the vehicle and weather information.

The control pattern may include at least one of a control order, control values, and a control frequency for the plurality of convenient devices.

### BRIEF DESCRIPTION OF THE DRAWINGS

FIG. 1 is a diagram illustrating an apparatus of automatically controlling a convenient device for a vehicle according to an exemplary embodiment of the present inventive concept.

FIG. 2 is a diagram illustrating a method of automatically controlling a convenient device for a vehicle according to an exemplary embodiment of the present inventive concept.

FIG. 3 is a diagram illustrating a method of generating a macro according to an exemplary embodiment of the present inventive concept.

FIG. 4 is a diagram illustrating a macro guide screen according to an exemplary embodiment of the present inventive concept.

FIG. 5 is a diagram illustrating a method of recommending a macro according to an exemplary embodiment of the present inventive concept.

FIG. 6 is a diagram illustrating a macro modification inquiry screen according to an exemplary embodiment of the present inventive concept.

### DETAILED DESCRIPTION OF THE EMBODIMENTS

Hereinafter, exemplary embodiments of the present inventive concept will be described in detail with reference to the accompanying drawings. In the accompanying drawings, portions unrelated to the description will be omitted in order to obviously describe the present disclosure, and similar reference numerals will be used to describe similar portions throughout the present specification.

Throughout the present specification, unless explicitly described to the contrary, “comprising” any components will be understood to imply the inclusion of other elements rather than the exclusion of any other elements. In addition, the terms “-unit,” “-er,” “-or,” and “module” described in the specification mean units for processing at least one function and operation and can be implemented by hardware components or software components and combinations thereof.

Terms used throughout the specification, “first,” “second,” “third,” etc.

can be used to describe various portions, components, regions, layers, and/or sections but are not limited thereto. These terms are used only to differentiate any portion, component, region, layer, or section from other portions, components, regions, layers, or sections. Therefore, a first control value, a first macro, and the like which are described below may be mentioned as a second control value and a second macro within a range without deviating from the scope of the present disclosure.

Throughout the present specification, the “convenient device' means an apparatus which does not affect driving or safety of a vehicle, provides driver related information to a driver while the vehicle is driven, or provides convenience to implement optimal environment when a driver drives the vehicle.

Throughout the present specification, the “macro” means making control instructions of a driver for a plurality of convenient devices for a vehicle into a single control instruction. In detail, the macro includes one control pattern generated based on a control order, control values, a control frequency, or the like of a driver for a plurality of convenient devices for a vehicle and environmental information at the time at which the one control pattern is generated.

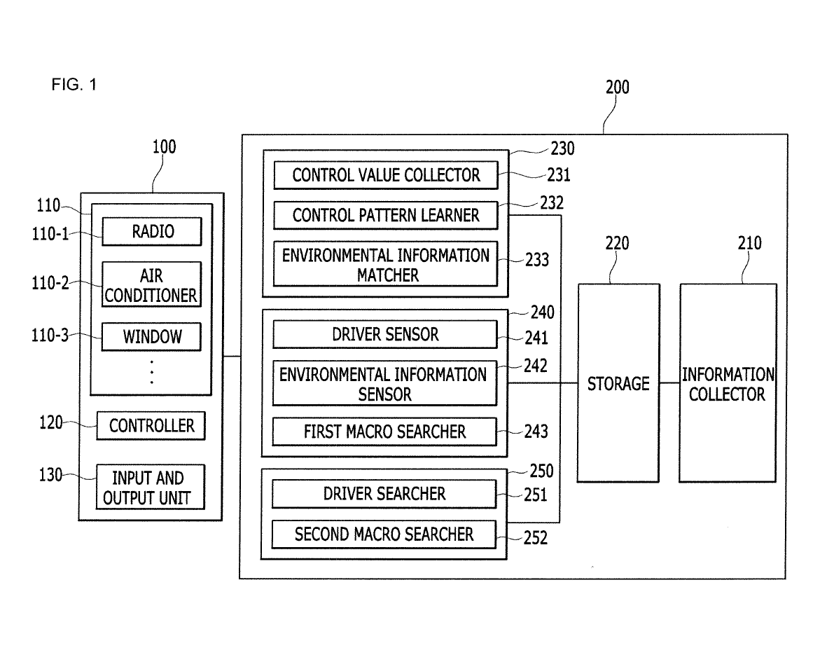

FIG. 1 is a diagram illustrating an apparatus of automatically controlling a convenient device for a vehicle according to an exemplary embodiment of the present inventive concept.

Referring to FIG. 1, an apparatus 200 for automatically controlling a convenient device for a vehicle includes an information collector 210, a storage 220, a macro generator 230, a macro provider 240, and a macro recommender 250.

The information collector 210 collects environmental information, driver information of other vehicles, and macro information corresponding to driver information of the other vehicles from a remote center. The environmental information means information associated with vehicle external environment and includes at least one of date, day, time, weather, a position of a vehicle, a driving area of the vehicle, and weather information of the driving area of the vehicle. The driver information includes a vehicle model, a sex of the driver, ages of the driver, a residential area of the driver, a driving habit, and an accident history. The macro information means control information of the driver on the convenient device for the vehicle and detailed contents thereof will be described in the following environmental information matcher 233. Further, the information collection unit 210 may directly collect macro information from other vehicles.

The environmental information, the driver information, and the macro information which are collected by the information collector 210 are stored in the storage 220 and if necessary, are provided to the macro generator 230, the macro provider 240, or the macro recommender 250.

The macro generator 230 includes a control value collector 231, a control pattern learner 232, and an environmental information matcher 233.

The control value collector 231 collects control values (manipulation values) of the driver for a convenient device 110 of the vehicle. The convenient device 110 includes a radio 110-1, an air conditioner 110-2, a driver or passenger side window 110-3, and the like.

For example, when the driver manipulates a frequency and a volume of the radio 110-1, the control value collector 231 may collect control values such as “frequency 107.7 FM” and “Vol.7”.

The control pattern learner 232 learns a control pattern of the driver for the convenient device 110 based on the control values collected by the control value collector 231. In this case, the control pattern includes at least one of a control order, control values, and a control frequency of the driver for a plurality of convenient devices 110.

For example, when the driver repeats a behavior of opening and closing the driver side window 110-3 and then sequentially manipulating the radio 110-1 and the air conditioner 110-2 several times, the control pattern learner 232 learns this behavior as one pattern and stores a learned result as a control pattern such as “open driver's seat window -> close driver's seat window -> turn on radio -> turn on air conditioner”. In this case, the control pattern may include detailed control values of the radio and the air conditioner, that is, the radio frequency, the volume of the radio, the temperature of the air conditioner, and the like.

The environmental information matcher 233 matches the control pattern learned by the control pattern learner 232 with the environmental information collected by the information collector 210 to generate a macro. In this case, the environmental information means the environmental information when the control pattern is generated.

In detail, the environmental information matcher 233 generates the macro based on at least one environmental information set by the driver. For example, when the driver sets time information and position information as the environmental information for macro generation, one macro may be generated by matching the control pattern “open driver's seat window -> close driver's seat window -> turn on radio -> turn on air conditioner” with time (6 p.m.) and position (Samsung-dong, Gangnam-gu, Seoul) information at which the control pattern is generated. Then, the macro generated from the environmental information matcher 233 is stored in the storage 220.

The macro provider 240 includes a driver sensor 241, an environmental information sensor 242, and a first macro searcher 243.

The driver sensor 241 identifies a driver in the vehicle. In detail, the driver may be identified by a portable terminal of the driver which is connected by near field communication to control the convenient devices 110. Further, the driver may be identified based on a seat position, a smart key, or an identification (ID) number input from the driver.

The environmental information sensor 242 collects the environmental information when the driver boards the vehicle or the vehicle starts.

The first macro searcher 243 searches for the macro corresponding to the driver identified by the driver sensor 241 and the environmental information collected by the environmental sensor 242. Further, macro search results (macro list) are provided to the driver through the input and output 130 and the plurality of convenient devices 110 are automatically controlled without the manipulation of the driver by a controller 120 based on the macro selected by the driver.

In this case, when a manual control of some of the convenient devices 110 is sensed by the driver while the plurality of convenient devices 110 are automatically controlled, the control value collector 231 collects and stores manual control values. After a control value modification intention of the driver is confirmed, the existing macro is modified or a new macro may be generated by matching the environmental information at the time at which the manual control is performed by the environmental information matcher 233.

For example, when the behavior of opening the driver side window is repeated by the driver for predetermined times while the convenient devices 110 are controlled as “open driver's seat window -> close driver's seat window -> turn on radio -> turn on air conditioner” depending on the macro selected by the driver, it is inquired to the driver whether the driver has an intention to modify the control pattern of the macro. The control pattern is then modified depending on a driver's response and reflected to the macro, and the macro including the modified control pattern may be provided to the driver.

The macro recommender 250 includes a driver searcher 251 and a second macro searcher 252.

The driver searcher 251 searches for drivers of other vehicles including the driver information corresponding to the driver in the current vehicle based on the driver information of the other vehicles collected by the information collector 210.

The second macro searcher 252 searches for the macro information corresponding to the searched drivers of the other vehicles based on the driver information search result of the driver searcher 251, and provides the macro search results to the driver.

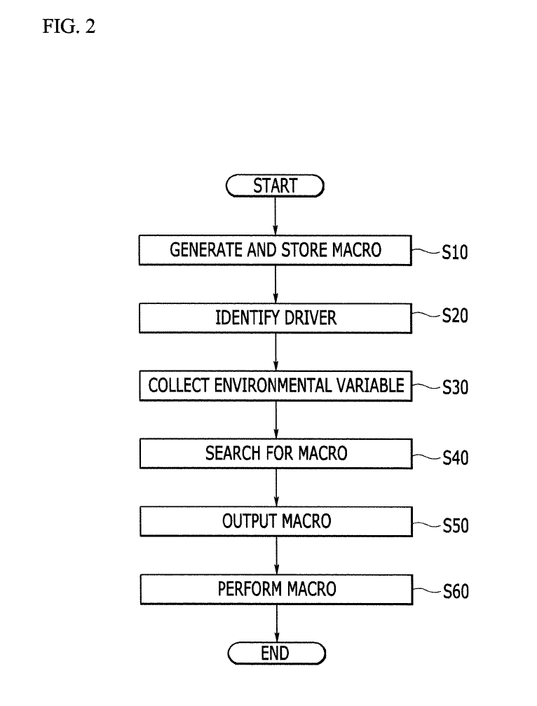

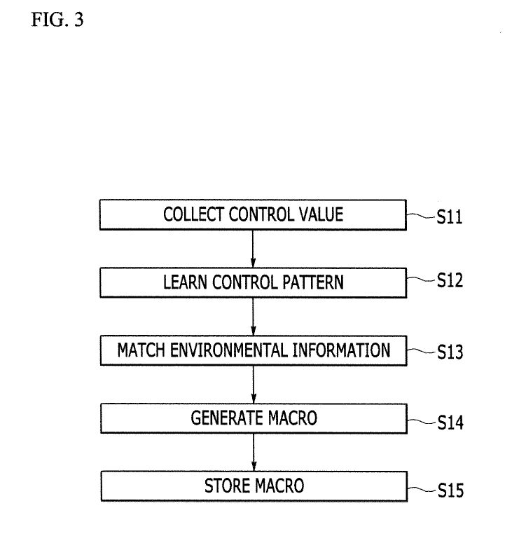

FIG. 2 is a diagram illustrating a method of automatically controlling a convenient device for a vehicle according to an exemplary embodiment of the present inventive concept. FIG. 3 is a diagram illustrating a method of generating macro according to an exemplary embodiment of the present inventive concept.

As illustrated in FIG. 2, the macro generator 230 generates and stores macros for each driver (S10). In detail, as illustrated in FIG. 3, the control value collector 231 collects control values of the driver for the convenient devices 110 (S11). The control pattern learner 232 learns a control pattern of the driver for the plurality of convenient devices 110 based on the control values collected by the control value collector 231 (S12). Next, the environmental information matcher 233 matches the control pattern with environmental information set as a macro generation condition by the driver (S13). Finally, the environmental information matcher 233 generates the macro depending on the matched result (S14) and stores the generated macro in the storage 220 (S15).

For example, the macro generator 230 learns the control pattern for a behavior of the driver of first adjusting a seat position in the vehicle, opening a driver side window, manipulating an air conditioner, and closing the driver side window, and collects the environmental information (environmental information set as the macro generation condition by the driver) at the time at which the seat, the window, and the air conditioner are controlled. When the environmental information set by the driver is time and weather information, a macro of “seat position adjustment -> open driver's seat window -> drive air conditioner at 21 ° C. -> close driver's seat window” may be generated at 6 p.m. and under fine weather.

The driver sensor 241 identifies the driver in the vehicle (S20). The environmental information sensor 242 then collects the environmental information when the driver boards the vehicle or the vehicle starts (S30). Next, the first macro searcher 243 searches for the macro corresponding to the identified driver and the environmental information (S40) and outputs the macro search results to the driver through the input and output unit 130 (S50). The first macro searcher 243 executes one macro selected among the macro search results by the driver (S60) and then the process ends.

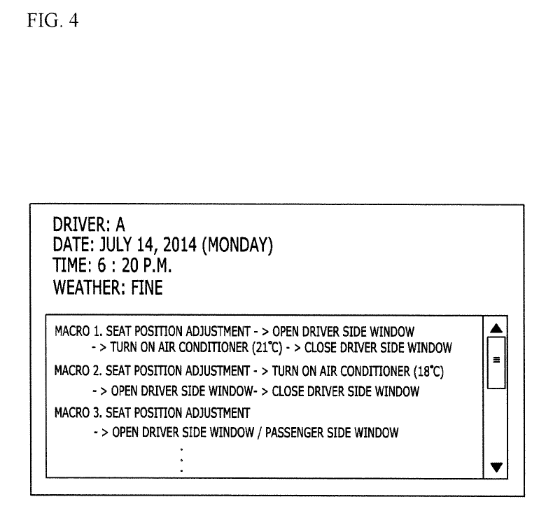

FIG. 4 is a diagram illustrating a macro guide screen according to an exemplary embodiment of the present inventive concept.

Referring to FIG. 4, driver and environmental information, such as a driver, date, time, and weather, and a macro list corresponding to the driver and environmental information are provided to the driver. When any one macro to from the macro list is selected by the driver, the plurality of convenient devices 110 may be automatically controlled based on the selected macro. For example, when the driver selects macro 3, the seat position is automatically controlled without the manipulation of the driver, and then the driver side and passenger side windows are opened.

Further, in the step of outputting the macro (S50), the macros of other drivers may be recommended to the driver.

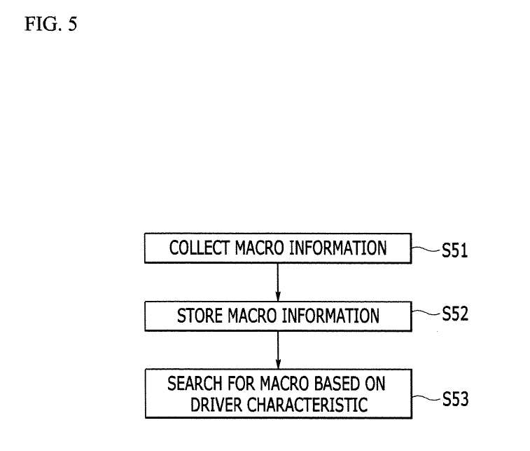

FIG. 5 is a diagram illustrating a method of recommending macro according to an exemplary embodiment of the present inventive concept.

First, the information collector 210 collects the driver information of other vehicles and the macro information corresponding thereto from a remote center or the other vehicles (S51).

The macro information corresponding to the collected driver information of the other vehicles is stored in the storage 220 (S52).

The driver searcher 251 searches for the drivers of the other vehicles including the driver information corresponding to the driver identified in the identifying of the driver (S20) and searches for the macro information corresponding to the searched drivers of the other vehicles and provide the searched macro information to the driver through the input and output 130 (S53).

For example, for a driver A includes information “men in 30′s, SUV vehicle, and urban dwelling”, when the driver searcher 251 searches for the driver including information which corresponds to the men in 30′s, sex (male), vehicle model (SUV vehicle), and residence (city) and searches for a driver B having similar information to the driver A, the macro information of the driver B may be provided to the driver A.

The method of automatically controlling a convenient device for a vehicle according to an exemplary embodiment of the present inventive concept may further include modifying a macro.

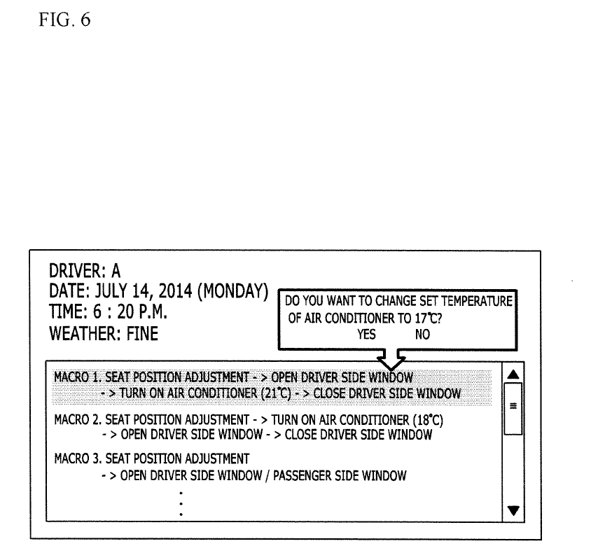

FIG. 6 is a diagram illustrating a macro modification query screen according to an exemplary embodiment of the present inventive concept.

As illustrated in FIG. 2, when manual control of the convenient devices 110 is sensed by the manipulation of the driver while the convenient devices 110 are automatically controlled, the first macro searcher 243 collects and stores the manual control values through the control value collector 231. Next, when the corresponding macro is selected by the driver, an inquiry screen as illustrated in FIG. 6 is output prior to confirming whether to modify the macro.

In detail, when a temperature of the air conditioner is repeatedly changed to 17° C. by the driver while the convenient devices 110 are controlled by the macro 1, the control value 17 ° C. is separately stored. When the driver selects the macro 1 in selecting the macro as illustrated in FIG. 6, a message inquiring whether to modify the temperature of the air conditioner among the control patterns within the macro to the control value 17 ° C. may be output. In this case, when the driver selects “yes,” the control temperature of the air conditioner in the macro 1 is changed to 17 ° C. and stored. When the macro 1 is executed, the convenient devices 110 may be automatically controlled depending on the control pattern of “seat position adjustment -> open driver side window -> turn on air conditioner (17 ° C.) -> close driver side window.

According to the exemplary embodiment of the present inventive concept, it is possible to reduce the driver inconvenience of manipulating the plurality of convenient devices within the vehicle one by one when the driver is the vehicle by automatically controlling the plurality of convenient devices. Further, it is possible to more efficiently control the plurality of convenient devices in consideration of the external environmental information of the vehicle. Further, it is possible to recommend or share the control information on the convenient devices among the drivers.

While this disclosure has been described in connection with what is presently considered to be practical exemplary embodiments, it is to be understood that the disclosure is not limited to the disclosed embodiments, but on the contrary, is intended to cover various modifications and equivalent arrangements included within the spirit and scope of the appended claims.

What is claimed is:

1. An apparatus of automatically controlling a convenient device for a vehicle, the apparatus comprising:
a macro generator configured to collect control values of a driver for a plurality of convenient devices for the vehicle to learn a control pattern of the driver, to collect environmental information after the control pattern is generated, and to generate a macro by matching the learned control pattern with the environmental information; and
a macro provider configured to identify the driver in the vehicle, to collect the environmental information, to search for the macro corresponding to the identified driver and the environmental information, and to provide macro search results to the driver when the driver boards the vehicle.

2. The apparatus of claim 1, further comprising:
a macro recommender configured to search for drivers of other vehicles including driver information corresponding to the identified driver and search for macro information corresponding to the searched drivers of the other vehicles based on driver information of the other vehicles collected by an information collector and the macro information corresponding to the driver information of the other vehicles.

3. The apparatus of claim 1, wherein the macro generator sets the macro based on at least one environmental information set by the driver.

4. The apparatus of claim 1, wherein the macro provider senses at least one of a portable terminal of the driver connected by near field communication (NFC) to control the convenient devices for the vehicle, a seat position, and an identification (ID) input from the driver to identify the driver.

5. The apparatus of claim 1, wherein the macro provider automatically controls the plurality of convenient devices for the vehicle based on the macro selected by the identified driver.

6. The apparatus of claim 5, wherein when the macro generator senses a manual control by the driver while the plurality of convenient devices are controlled, a new macro is generated based on manual control values.

7. The apparatus of claim 1, wherein the environmental information includes at least one of date, day, time, season, a position of the vehicle, and weather information.

8. The apparatus of claim 1, wherein the control pattern includes at least one of a control order, control values, and a control frequency for the plurality of convenient devices for the vehicle.

9. A method of automatically controlling a convenient device for a vehicle, the method comprising:
collecting control values of a driver for a plurality of convenient devices for the vehicle;
learning a control pattern of the driver based on the control values;
collecting environmental information when the control pattern is generated; and
generating a macro by matching the learned control pattern with the environmental information.

10. The method of claim 9, further comprising steps of:
identifying the driver in the vehicle;
collecting the environmental information when the driver boards the vehicle;
searching for a macro corresponding to the identified driver and the environmental information when the identified driver boards the vehicle; and
providing macro search results to the identified driver.

11. The method of claim 10, further comprising steps of:
collecting driver information of other vehicles and macro information corresponding thereto from a remote center or the other vehicles;
searching for drivers of the other vehicles including driver information corresponding to the identified driver; and
providing the macro information corresponding to the searched drivers of the other vehicles to the identified driver.

12. The method of claim 10, further comprising a step of:
automatically controlling the plurality of convenient devices based on the macro selected by the identified driver among the macro search results.

13. The method of claim 9, wherein the environmental information includes at least one of date, day, time, season, a position of the vehicle, and weather information.

14. The method of claim 9, wherein the control pattern includes at least one of a control order, control values, and a control frequency for the plurality of convenient devices.
